(19) United States
(12) Patent Application Publication
(10) Pub. No.: US 2009/0252994 A1
(43) Pub. Date: Oct. 8, 2009

(54) BATTERY PACK SYSTEM

(76) Inventor: Alexander Livingston, Eagle, ID (US)

Correspondence Address: DYKAS, SHAVER & NIPPER, LLP, P.O. BOX 877, BOISE, ID, 83701-0877, US

(21) Appl. No.: 12/419,117

(22) Filed: Apr. 6, 2009

Related U.S. Application Data
(60) Provisional application No. 61/042,645, filed on Apr. 4, 2008.

(51) Int. Cl. H01M 2/06

(52) U.S. Cl. 429/1

(57) ABSTRACT

The invention described here is a modular energy system for electric vehicles. This modular electrical power system is comprised of a group of battery packs, a rack, and a charging and exchange station. Each battery pack fits into a case that has a handle to make it easy to grasp and lift from its holder. Battery packs are limited to no more than thirty pounds each. The battery packs are installed in a rack which is secured to the vehicle. The rack has defined positions or slots in which the battery packs are placed. The battery pack includes heat sinks to remove the heat from the batteries. The charging and exchange station allows the user two options; 1) recharge the vehicle while parked without removing the batteries, or 2) exchange the vehicles batteries for fully charged packs.

### PRIORITY/CROSS-REFERENCE TO RELATED APPLICATIONS

This application claims the priority date of the provisional application entitled Battery Pack System filed by Alexander Livingston on Apr. 4, 2008, with application Ser. No. 61/042,645, the disclosure of which is incorporated by reference.

### FIELD OF THE INVENTION

The invention generally relates to an apparatus for a battery system for electric vehicles and, more particularly, to removable modular batteries and a battery rack to provide power for an electric vehicle.

### BACKGROUND OF THE INVENTION

Hybrid electric vehicles which employ battery power together with power from an engine driven electrical generator, and plug in electric vehicles which rely entirely on batteries for power are becoming more common. Batteries for these vehicles tend to be heavy assemblies that require specialized equipment for installation and removal from the vehicle. When the battery in a hybrid vehicle needs charging or when vehicle performance needs a boost, the internal combustion engine starts and its generator charges the battery or directly supplies power to the vehicle. A plug in electrical vehicle is powered strictly from a battery bank that is charged by plugging into normal household electrical receptacles, typically at the driver's home. When the battery is charged, the vehicle will operate until the energy stored in the charged batteries is depleted. Issues with plug in electric vehicles at this time include: limited range and the time required to recharge the main battery when it is discharged.

The size, weight and complicated connections of conventional battery systems in vehicles prevent an individual from simply exchanging a battery when discharged. The plug in electric vehicle therefore, has to stop and recharge. A hybrid vehicle relies on its engine driven generator when unable to proceed on battery power. When the engine is running, the hybrid relies on liquid fuels which may include gasoline, diesel fuel, or ethanol. Internal combustion engines in automobiles are notoriously inefficient and the price of liquid fuels is high and unstable.

No facility or battery arrangement is available today that provides electric vehicles with the ability to refuel quickly at remote locations in a manner similar to liquid fueled vehicles filling up at a refueling station, and then proceeding to their destination with only a short delay. A modular battery system offers a solution to this problem, allowing the driver of an electric vehicle the ability to ‘refuel’ by exchanging discharged batteries for fully charged batteries in a short time without special equipment. Modular batteries may be recharged and dispensed at service stations along with liquid fuels. Additionally modular batteries may be recharged and dispensed from purpose built charging and vending stations.

### SUMMARY OF THE INVENTION

The invention described here is a modular electrical energy system for electric motor driven vehicles with or without an engine driven generator. This modular electrical power system is comprised of a group of battery packs. Each battery pack fits into a case that has a handle to make it easy to grasp and lift from its holder. Battery packs are limited to no more than thirty pounds each. The case has electrical power connectors on the outside for connection to the vehicle's power system. Each battery pack would have heat sinks or heat transfer plates as required to remove heat from the pack. The battery pack electrical power connectors are a shielded type to prevent inadvertent contact with conducting items and surfaces when they are being removed or installed.

The battery packs are installed in a rack which is secured to the vehicle. The rack has defined positions or slots in which the battery packs are placed. Each battery pack position includes electrical connectors that engage electrical connectors on the battery pack. When installed in the rack, battery packs are secured to ensure continuous electrical connection and to prevent unsecured battery packs from moving. Heat sinks arranged in the battery rack between the individual pack locations contact the heat sinks or heat transfer plates on the battery packs to remove the heat from the batteries.

Battery packs may also include indicator lights so the user could quickly examine some basic information about the individual battery packs. The information may include whether the pack is charged or discharged and whether or not the cell is connected to the vehicle. Also, indication of internal fault conditions in a battery pack may be signaled.

The batteries in each battery pack may be a single battery or cell, or a battery formed by an array of individual battery cells connected together to provide the desired voltage. Battery packs may contain an array of common batteries such as a type 18650 lithium ion battery cell as they are very common, have excellent energy density properties, and are relatively small. However, the source of electric power installed in the battery packs need not be traditional batteries but, for instance, could be capacitors, ultra-capacitors, or fuel cells. Each battery pack will be identified with a unique number to allow tracking repair status, and service history to assure the integrity and service life of the battery.

The third major component of this modular battery pack is a battery charging and exchange station. The charging and exchange station allows the user two options: 1) recharge the vehicle while parked without removing the batteries, or 2) exchange the vehicles batteries for fully charged packs.

The battery charge and exchange station includes a user interface terminal where the user selects the desired service and provides payment information such as a debit or credit card number. After payment, the vehicle is recharged while parked or discharged batteries are exchanged for fully charged batteries.

Battery charge and exchange stations will maintain a data base to track individual battery packs by their identification numbers. Each battery pack will be tested when received, and again, after charging by the charge and exchange station

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 shows an embodiment of a battery back.

FIG. 2 shows an embodiment of a battery rack.

FIG. 3 shows one embodiment of a battery rack with several battery packs installed.

FIG. 4 is a schematic of a battery charge and exchange station.

FIG. 5 is a flow chart for operation of a battery charge and exchange station.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

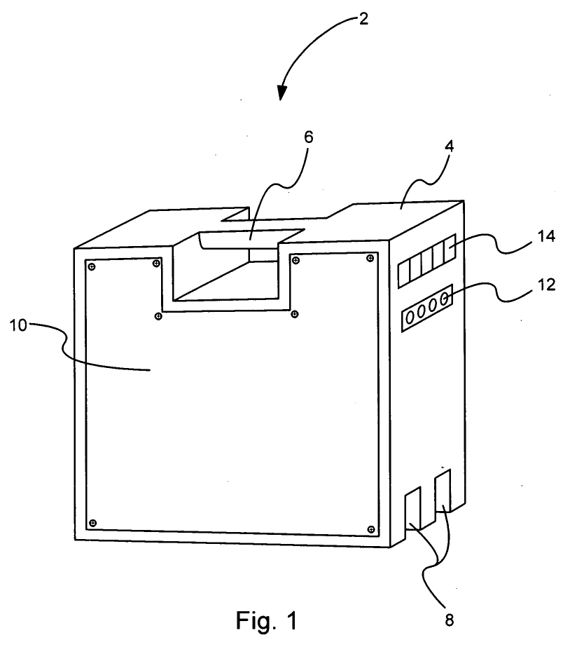

Referring now to FIG. 1, a battery pack 2 is illustrated. The battery pack case 4 includes a handle 6 to allow the user to grasp and easily lift the battery pack. Electrical connectors 8 installed on the exterior of the battery pack case are of the type commonly used in electric vehicle battery connections. The side plate and heat sink 10 is removable to provide access to battery cells located inside the pack. A diagnostic connecter 12 allows the vehicle electrical systems to monitor the condition of the battery pack. Indicator lights are installed on the pack to provide the operator or user with a visual indication of the battery packs condition or status. It is understood that energy sources other than batteries could be installed in this pack including ultra-capacitors or electrical-capacitors.

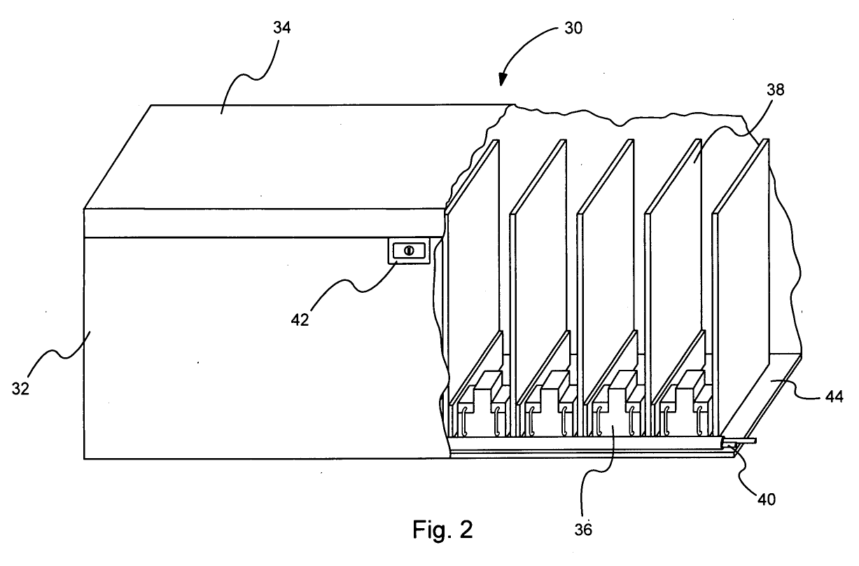

Referring to FIG. 2, the battery rack 30 is shown. The rack base 44 will be secured to the vehicle structure and enclosed with a case 32 and a cover 34 which can be secured closed by a latch or latches 42. The cover serves dual purposes in this embodiment in that it restrains the battery packs so they cannot move in response to vehicle acceleration and deceleration and also holds the packs in secure contact with the mating electrical connectors 36 inside the battery rack. Power cables 40 route to the battery rack to connect batteries to the vehicles' electrical power system. Heat sinks 38 also serve to separate the individual battery positions inside the battery rack. These heat sinks circulate a cooled fluid and are in contact with the heat sinks 10 on the battery packs and they serve to transfer heat from the batteries to an external cooling system that is part of the vehicle itself.

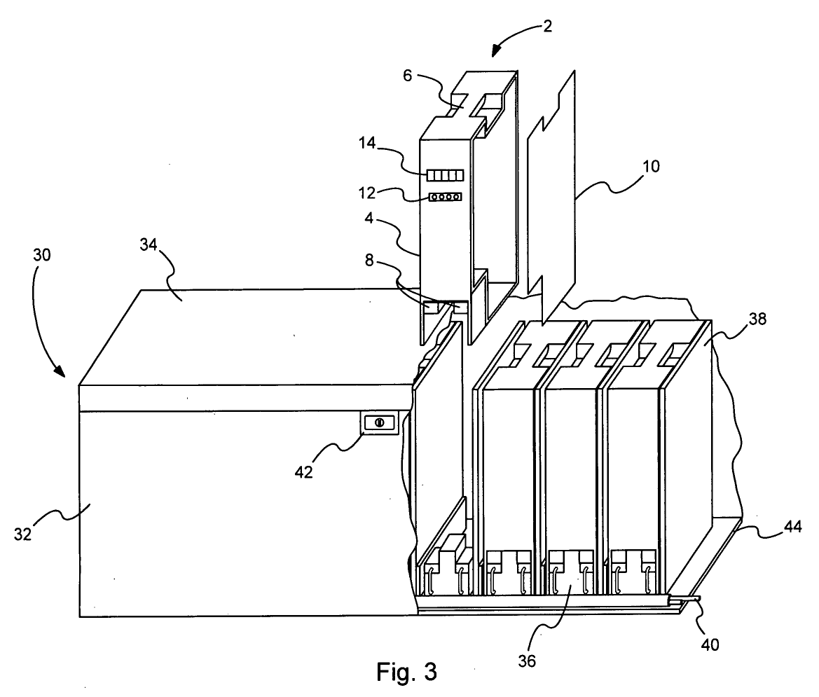

FIG. 3 shows the battery rack 30 and a number of battery packs 2 as they would be installed in the vehicle in this cutaway view. In this illustrated embodiment, the cover on the battery rack secures the batteries in position, restraining them mechanically and also assuring that a high quality electrical connection is maintained between the battery and the battery rack. Other embodiments may use modified latching systems such as individual latches provided for each battery pack, or a bar that crosses the top of the battery packs and restrains them in a manner similar to the cover 34 as shown in this figure.

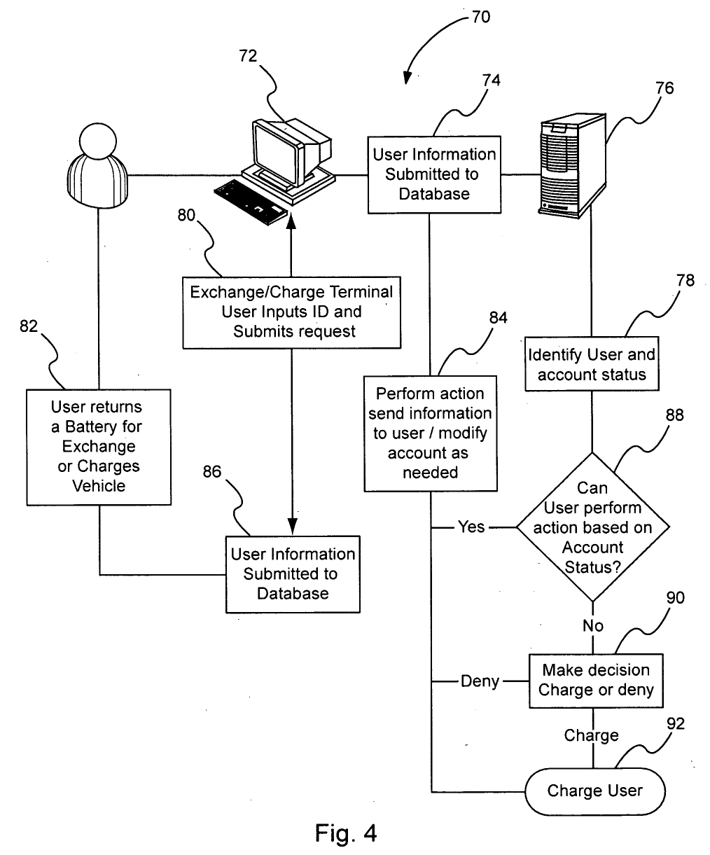

FIG. 4 illustrates a schematic flow diagram for the battery charge and exchange station 70. At 82 the process begins with the return of a battery pack for exchange or a request for a parked charging process. At 86 data from the battery packs to be charged is submitted to the data base computer 76. The user accesses the system through the user terminal 72 and inputs customer identification information and submits a request of the desired services at 80. The user information provided is submitted to the data base computer 76, as can be seen at block 74. With the information input completed, the system identifies the user and account status at 78. A decision is made whether the user can perform the action based on the current account status at 88 and a decision is made at 90 to charge the user or to deny the services requested. The results of these decisions are sent to the user at 92 and, if needed, the account is modified at 84.

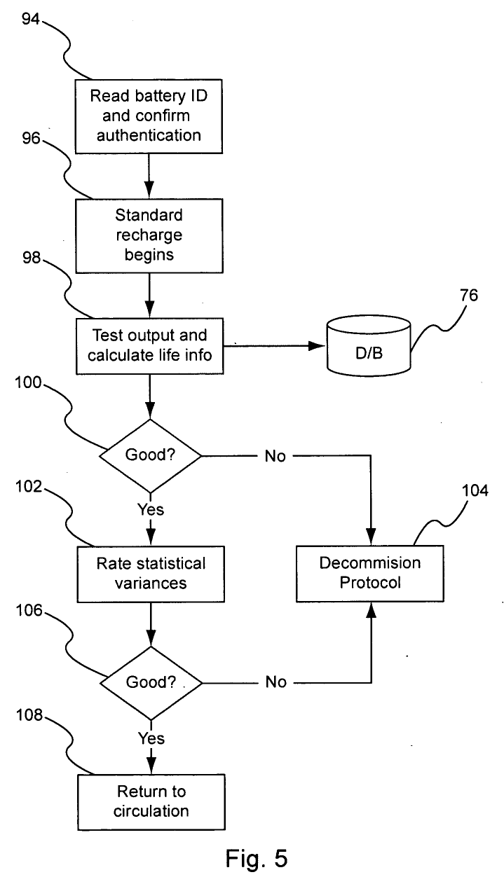

FIG. 5 shows a flow diagram for the charging service at the battery charge and exchange stations. When a battery is connected to the station for charging, its ID is read and confirmed at 94. After battery ID, the charge and exchange station begins a standard recharge at 96. Battery output is tested and the life data is calculated at 98; this information is reported to the charge and exchange station data base computer at 76. The results of the test and life calculation are used to decide 100 whether the battery is good and the charge should continue, or whether the battery has failed and the battery should be processed through a decommissioning protocol 104. If the battery is suitable for further service and is not decommissioned, the battery is rated and its statistical record is evaluated during the charging process. The battery is again evaluated after charging and a decision is made at 106 whether the battery is good and returned to circulation block at 108 or, if the battery has failed during the charging process and will be handled through the decommissioning protocol 104.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A modular electrical power system for electric vehicles with a motor, said system comprising:
a plurality of energy packs, with each energy pack comprising a case with an integral handle for containing at least one energy cell, at least one lockdown fitting configured for operative engagement with a latch on an energy pack rack, with each said energy pack weighing less than 30 pounds, with said case comprising electrical power connectors configured to prevent reversed polarity connection; and
at least one rack configured for attachment to said electric vehicle, configured for interfitting engagement with said plurality of energy packs, said rack comprising a rack base for attachment to a vehicle, said rack base including a plurality of defined positions for said energy packs, each of said energy pack positions comprising electrical connections for operative connection with said energy pack electrical power connectors to said vehicle power and diagnostic system, a latch configured to engage said lockdown fitting on said energy packs, and a plurality of heat sinks arranged for contact with said energy packs with said heat sinks configured for contact with said energy packs for the purpose of energy pack heat rejection.

2. The modular electrical power system for electric vehicles of claim 1 which further comprises:
an energy pack charge and exchange station comprising a user interface terminal configured to accept information input by a station user, said information comprising user identification, financial information related to payment for services and services desired;
an energy pack exchange and deposit bay configured to receive and dispense energy packs, comprising an energy pack charger pendant cable, configured for connection to said electric vehicle, and an energy pack charger, with said energy pack charger configured to charge individual energy packs when said individual energy packs are placed in said energy charge and exchange station, said energy pack charger configured to charge a parked electrical vehicle energy system when said vehicle is connected to said energy pack charge and exchange station by said energy pack charger pendant cable.

3. The modular electrical power system for electric vehicles of claim 1 in which said energy packs are comprised of one or more batteries.

4. The modular electrical power system for electric vehicles of claim 1 in which said energy packs are comprised of one or more capacitors.

5. The modular electrical power system for electric vehicles of claim 1 in which said energy packs are comprised of hydrogen fuel cells.

6. The modular electrical power system for electric vehicles of claim 3 in which said energy pack case contains a plurality of cells connected to form a battery with desired voltage and energy storage.

7. The modular electrical power system for electric vehicles of claim 1 in which said case with an integral handle further comprises indicator lights configured to signal status of charge, connection status and fault conditions.

8. The modular electrical power system for electric vehicles of claim 7 in which said indicator lights are LEDs.

9. The modular electrical power system for electric vehicles of claim 1 in which said energy pack case with an integral handle includes an electrical connector configured for electrical connection with a monitoring system.

10. The modular electrical power system for electric vehicles of claim 1 in which said energy pack case further comprises a plurality of energy pack heat transfer plates to remove heat from said energy packs by contact with said heat sinks on said racks.

11. The modular electrical power system for electric vehicles of claim 1 in which said energy pack case further comprises one or more unique identification numbers.

12. The modular electrical power system for electric vehicles of claim 3 in which said power pack is comprised of a plurality of standard lithium ion cells.

13. The modular electrical power system for electric vehicles of claim 12 in which said power pack is comprised of a plurality of standard 18650 lithium ion cells.

14. The modular electrical power system for electric vehicles of claim 1 in which said electrical power connectors on said energy packs include a shield for covering said energy pack terminals when said energy pack is removed from said energy pack rack.

15. The modular electrical power system for electric vehicles of claim 1 in which said energy pack rack heat sinks are water filled units positioned to contact said energy pack case when said energy pack cases are installed and locked in place in said rack.

16. The modular electrical power system for electric vehicles of claim 10 in which said energy pack rack heat sinks are positioned to contact said heat transfer plates of said energy pack case when said energy pack cases are installed and locked in place in said rack.

17. The modular electrical power system for electric vehicles of claim 1 where said battery rack heat sinks further comprise one or more air channels positioned to direct cooling airflow over and through said energy pack heat sinks.

18. A modular electrical power system for electric vehicles with a motor, said system comprising:
a plurality of energy packs, with each energy pack comprising a case with an integral handle for containing at least one energy cell, at least one lockdown fitting configured for operative engagement with a latch on an energy pack rack, with each said energy pack weighing less than 30 pounds, with said case comprising electrical power connectors configured to prevent reversed polarity connection;
at least one rack configured for attachment to said electric vehicle, configured for interfitting engagement with said plurality of energy packs, said rack comprising a rack base for attachment to a vehicle, said rack base including a plurality of defined positions for said energy packs, each of said energy pack positions comprising electrical connections for operative connection with said energy pack electrical power connectors to said vehicle power and diagnostic system, a latch configured to engage said lockdown fitting on said energy packs, and a plurality of heat sinks arranged for contact with said energy packs with said heat sinks configured for contact with said energy packs for the purpose of energy pack heat rejection;
an energy pack charge and exchange station comprising a user interface terminal configured to accept information input by a station user, said information comprising user identification, financial information related to payment for services and services desired; and
an energy pack exchange and deposit bay configured to receive and dispense energy packs, comprising an energy pack charger pendant cable, configured for connection to said electric vehicle, and an energy pack charger, with said energy pack charger configured to charge individual energy packs when said individuals energy packs are placed in said energy charge and exchange station said energy pack charger configured to charge a parked electrical vehicle energy system when said vehicle is connected to said energy pack charge and exchange station by said energy pack charger pendant cable
